(19) United States
(12) Patent Application Publication
(10) Pub. No.: US 2013/0306832 A1
(43) Pub. Date: Nov. 21, 2013

(54) Supporting Apparatus for Glass Substrate Cartridge

(71) Applicants: Yongqiang Wang, Shenzhen (CN); Chunhao Wu, Shenzhen (CN); Kunhsien Lin, Shenzhen (CN); Xiande Li, Shenzhen (CN); Erqing Zhu, Shenzhen (CN); Minghu Qi, Shenzhen (CN); Weibing Yang, Shenzhen (CN); Zenghong Chen, Shenzhen (CN); Zhenhua Guo, Shenzhen (CN); Yunshao Jiang, Shenzhen (CN)

(72) Inventors: Yongqiang Wang, Shenzhen (CN); Chunhao Wu, Shenzhen (CN); Kunhsien Lin, Shenzhen (CN); Xiande Li, Shenzhen (CN); Erqing Zhu, Shenzhen (CN); Minghu Qi, Shenzhen (CN); Weibing Yang, Shenzhen (CN); Zenghong Chen, Shenzhen (CN); Zhenhua Guo, Shenzhen (CN); Yunshao Jiang, Shenzhen (CN)

(73) Assignee: SHENZHEN CHINA STAR OPTOELECTRONICS TECHNOLOGY CO. LTD., Shenzhen (CN)

(21) Appl. No.: 13/518,832

(22) PCT Filed: May 22, 2012
(86) PCT No.: PCT/CN12/75844

§ 371 Date: Jun. 22, 2012

(30) Foreign Application Priority Data
May 17, 2012 (CN) 201210153960.2

(51) Int. Cl. F16M 13/00

(52) U.S. Cl. 248/631; 248/560; 248/618

(57) ABSTRACT

The present invention introduces a solution by providing a supporting apparatus for glass substrate and which comprises a first supporting member creating a first supporting surface along a first horizontal direction. A second supporting member is included to create a second supporting surface and arranged spatially and perpendicular to the first supporting member. The supporting apparatus further includes at least two buffering devices arranged between the first and second supporting surfaces for providing an attenuating effect when a fully loaded cartridge is landed thereupon.

### FIELD OF THE INVENTION

The present invention relates to a field of liquid crystal display, and more particularly, to a supporting apparatus for glass substrate cartridge.

### BACKGROUND OF THE INVENTION

During the manufacturing the liquid crystal display panel, the glass substrates are generally carried within a cartridge and then moved to different workstations. Typically, a cartridge can stack upto fifty-six (56) sheets of glass substrates. However, when those glass substrates are stacked within the cartridge, every two adjacent glass substrates are spaced merely twenty-one (21) millimeters, and as the glass substrate has a comparable larger dimension, typically 500 mm×2200 mm with a thickness of 0.4˜0.7 mm. It is vulnerable to break apart under shock because of its extreme brittleness. Accordingly, care has to be taken so as to avoid such detrimental situation.

In an automatic transportation system, the cartridge carried with glass substrates can be moved by an automatic transportation vehicle or manually. Currently, a mover is moved to the cartridge to lift it up with its forks. Then the cartridge is moved to a supporting platform.

Since cartridge is disposed on the supporting platform in a head-to-head manner without any buffer therebetween, and the weight of a fully loaded cartridge can reach to seven hundred and forty kilograms (740 kg), a rough touch down or landing of the cartridge onto the supporting platform can easily create a shockwave to break the glass substrates within the cartridge. If this is happen, a grave loss of the glass substrates will be encountered.

It is therefore a necessity to provide a supporting apparatus for cartridge to effectively reduce any shockwave during the landing or touch-down of the cartridge onto the supporting platform. As a result, damages from breaking the glass substrates can be avoided.

### SUMMARY OF THE INVENTION

The main issue of prior art will be addressed by the present invention as a supporting apparatus for supporting glass substrate cartridge is provided. The supporting apparatus is specially provided with a buffering device which can effectively attenuate any shockwave resulted from a rough landing of the cartridge on the supporting apparatus.

In order to resolve the technical issue discussed above, the present invention introduces a solution by providing a supporting apparatus for glass substrate and which comprises a first supporting member creating a first supporting surface along a first horizontal direction. A second supporting member is included to create a second supporting surface, and arranged spatially and perpendicular to the first supporting member. The supporting apparatus further includes at least two buffering devices arranged between the first and second supporting surfaces for providing an attenuating effect when a fully loaded cartridge is landed thereupon.

Wherein the first supporting member is configured with at least two first supporting hoards spatially arranged along the horizontal direction to define the first supporting surface, the second supporting member is configured with at least two second supporting boards spatially arranged along the horizontal direction to define the second supporting surface.

Wherein the buffering devices includes a cylinder configured by a body and a piston moveably disposed within the body, and a piston rod having a first end interconnected to the piston and a second end extending out of the body, the body is securely attached to the first supporting member, and the second supporting member is securely attached to the second end of the piston rod.

Wherein the buffering device further includes a connecting hoard interconnected to the second ends of the piston rod so as to simultaneously move upward and downward with the pistons within the body, the second supporting member is interconnected to the connecting board.

Wherein the buffering device includes a guiding rod and a elastic member, an end of the guiding rod is interconnected to the first supporting member and further extends along vertical direction, wherein the elastic member is enveloped onto the guiding rod and is arranged between the first and second supporting members.

Wherein the second supporting member is defined with a guiding hole in which a bushing is arranged for moveably supporting the second supporting member onto the guiding rod and to move along the guiding rod.

Wherein a stopper is arranged between the supporting member and the guiding rod so as to limit an upward stroke of the second supporting member.

Wherein the stopper includes a washer fixedly arranged on another end of the guiding rod limiting an upward movement of the second supporting by stopping the bushing of the second supporting member.

Wherein the elastic member is a spring or elastomer.

Wherein the second supporting member includes a plastic pad for supporting the cartridge thereon.

In order to resolve the technical issue discussed above, the present invention introduces a solution by providing a supporting apparatus for glass substrate and which comprises a first supporting member configured with at least two first supporting boards spatially arranged along the horizontal direction to define the first supporting surface. A second supporting member is provided and configured with at least two second supporting hoards spatially arranged along the horizontal direction and disposed above the first supporting hoards to define the second supporting surface which is vertically spatially with respect to the first supporting surface. At least two buffering devices are arranged between the first and second supporting surfaces for providing an attenuating effect when a loaded cartridge is landed thereupon. The buffering devices each includes a cylinder configured by a body and a piston moveably disposed within the body, and a piston rod having a first end interconnected to the piston and a second end extending out of the body. The body is securely attached to the first supporting member, and the second supporting member is securely attached to the second end of the piston rod.

Wherein the buffering device further includes a connecting board interconnected to the second ends of the piston rod so as to simultaneously move upward and downward with the pistons within the body, the second supporting member is interconnected to the connecting hoard.

Wherein the second supporting member includes a plastic pad for supporting the cartridge thereon.

In order to resolve the technical issue discussed above, the present invention introduces a solution by providing a supporting apparatus for glass substrate and which comprises a first supporting member configured with at least two first supporting boards spatially arranged along the horizontal direction to define the first supporting surface. A second supporting member is included and configured with at least two second supporting boards spatially arranged along the horizontal direction and disposed above the first supporting boards to define the second supporting surface which is vertically spatially with respect to the first supporting surface. At least two buffering devices each is arranged between the first and second supporting surfaces for providing an attenuating effect when a loaded cartridge is landed thereupon. Wherein the buffering device includes a guiding rod and an elastic member, an end of the guiding rod is interconnected to the first supporting member and further extends along vertical direction, wherein the elastic member is enveloped onto the guiding rod and is arranged between the first and second supporting members.

Wherein the second supporting member is defined with a guiding hole in which a bushing is arranged for moveably supporting the second supporting member onto the guiding rod and to move along the guiding rod.

Wherein a stopper is arranged between the supporting member and the guiding rod so as to limit an upward stroke of the second supporting member.

Wherein the stopper includes a washer fixedly arranged on another end of the guiding rod limiting an upward movement of the second supporting by stopping the bushing of the second supporting member.

Wherein the elastic member is a spring or elastomer.

Wherein the second supporting member includes a plastic pad for supporting the cartridge thereon.

The present invention can be concluded with the following advantages. As compared to the prior art supporting platform, the supporting apparatus made in accordance with the present invention can readily attenuate the shockwave resulted from a rough operation of placing the cartridge onto the supporting apparatus. As a result, breakage of the glass substrates contained within the cartridge resulted from vibrating and impact can be readily avoided. The supporting apparatus features a simple and compact configuration with lowered manufacturing cost, and it can be readily maneuvered.

### BRIEF DESCRIPTION OF DRAWINGS

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings. Wherein

FIG. 1 is an illustrational and elevational view of a supporting apparatus made in accordance with a first embodiment of the present invention;

FIG. 2 is a partially illustrational view of the supporting apparatus of FIG. 1;

FIG. 3 is an enlarged view of an encircled portion I of the supporting apparatus shown in FIG. 1;

FIG. 4 is an illustrational and elevational view of a supporting apparatus made in accordance with a second embodiment of the present invention;

FIG. 5 is a partially illustrational view of the supporting apparatus of FIG. 4;

FIG. 6 is an enlarged view of an encircled portion II of the supporting apparatus shown in FIG. 4;

FIG. 7 is an illustrational and elevational view of a supporting apparatus made in accordance with a third embodiment of the present invention;

FIG. 8 is a partially illustrational view of the supporting apparatus of FIG. 7; and

FIG. 9 is an enlarged view of an encircled portion III of the supporting apparatus shown in FIG. 7.

### DETAILED DESCRIPTION OF PREFERRED EMBODIMENTS

Detailed description of preferred embodiments will be given herebelow along with the accompanied drawings.

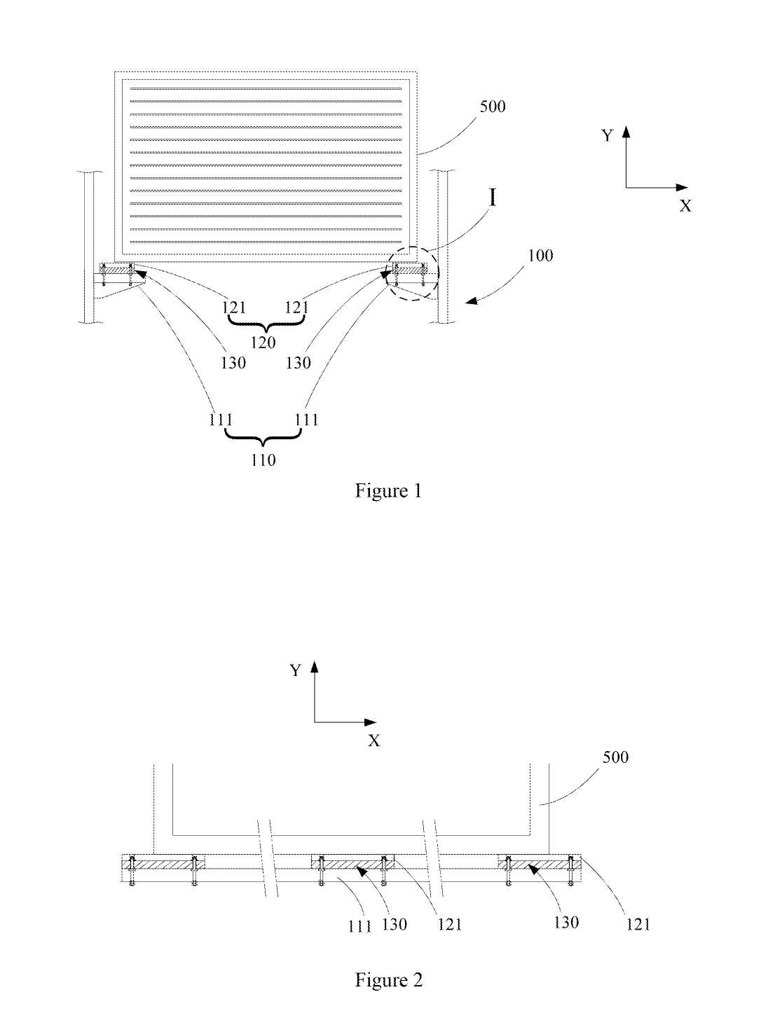

FIG. 1 is an illustrational and elevational view of a supporting apparatus made in accordance with a first embodiment of the present invention; and FIG. 2 is a partially illustrational view of the supporting apparatus of FIG. 1. As shown in FIGS. 1 and 2, the supporting apparatus 100 includes a first supporting member 110, and a second supporting member 120, and a pair of buffering devices 130.

The first supporting member 110 defines a first supporting surface along the horizontal direction X. In this embodiment, the first supporting member 110 includes a pair of first supporting boards 111 and which are spaced along the horizontal direction so as to define the first supporting surface. When the cartridge 500 for storing the glass substrates are disposed and placed onto the supporting apparatus 100, the gross weight of the cartridge 500 is fully loaded onto the first supporting member 110. Accordingly, the first supporting member 110 can be made from aluminum excursion structure or steel frame. The steel frame can be further coated and painted to as to provide an aesthetic appearance while is can functionally support the gross weight of the cartridge 500.

The second supporting member 120 is used to provide a second supporting surface along the horizontal surface, while it is vertically distant to the first supporting surface. In the present embodiment, the second supporting member 120 includes a pair of second supporting hoards 121 which are spatially arranged along the horizontal direction and located above the first supporting boards 111. The second supporting member 120 is provided with plastic pad, or alternatively, the second supporting member 120 is made from plastic material as a whole. The cartridge 500 can be readily supported onto the plastic pad. The function of the plastic pad used in the present invention is to separate the cartridge 500 from in contact with other parts or elements so as to avoid any dust resulted from direct friction encountered therebetween. In addition, the plastic pad can readily provide a lubricated surface facilitating easily sliding movement thereupon when the cartridge needs a final adjustment of its position. The plastic pad can be made from any material featured with low frictional coefficient and abrasion-proof material. For example, it can be made from polyoxymethylene or Teflon. As it is readily known to the skilled in the art and no further description is given.

The buffering device 130 is arranged between the first and second supporting surfaces. The buffering device 130 provides an attenuating effect to the cartridge 500 when it is landed onto the second supporting surface.

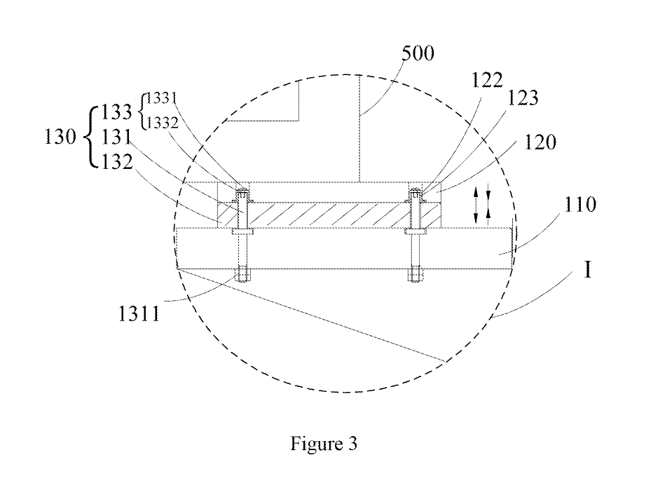

FIG. 3 is an enlarged view of an encircled portion I of the supporting apparatus shown in FIG. 1. As shown in FIG. 3, the buffering device 130 includes a guiding rod 131, an elastic member 132 and a stopper 133.

An end of the guiding rod 131 is securely attached to the first supporting member 110 by means of a nut 1311 and extends upwardly. Alternatively, in other embodiment, the guiding rod 131 can be securely attached to the first supporting member 110 by other proper means. As it is readily known to the skilled in the art and no detailed description is given.

The elastic member 132 is used to absorb the momentum of the cartridge 500 when it is landed. In the present embodiment, the spring member 132 can be made from other elastomer, such as polyurethane. As this is known to the skilled in the art, no detailed description is given. The second supporting member 120 is provided with a guiding hole 122 and a bushing 123 disposed within the guiding hole 122. The second supporting member 120 is enveloped onto the guiding rod 131 through the bushing, 123. The elastic member 132 is enveloped onto the guiding rod 131. In addition, the elastic member 132 is arranged between the first and second supporting members 110 and 120.

When a shock is generated when the cartridge 500 is disposed onto the supporting member 100, the guiding rod 131 provides a guiding arrangement to the upward and downward movement of the second supporting member 120. As a result, the second supporting member 120 will move along the guiding rod 131.

During the upward and downward movement of the second supporting member 120 along the guiding rod 121, the bushing 123 properly separates the second supporting member 120 and the guiding rod 131 such that no dust will be generated because of direct abrasive movement therebetween. In the present invention, the bushing 123 can be made with the material identical to the plastic pad. As a result, no detailed description is given.

Preferably, in the present embodiment, the stopper 133 is arranged between the second supporting member 120 and the guiding rod 131 so as to limit the upward movement of the second supporting member 120. The stopper 133 will prevent the second supporting member 120 from escaping from the guiding rod 131. The stopper 133 is configured by a screw member 1331 and a washer 1332 fixedly attach to the other end of the guiding rod 131. When the second supporting member 120 reaches to a preset height, the bushing 123 will be limited by the washer 1332. As result, the second supporting member will be limited from further displacing upward. Alternatively, the washer can be securely fixed to the other end of the guiding rod 131.

The elastic member 132 is used to absorb the downward momentum of the cartridge 500. Substantially, when the supporting apparatus 100 is unloaded with the cartridge 500, the washer 1332 and the hushing 123 will give a preset compression to the elastic member 1232. As a result, the position of the second supporting member 120 can be accurately positioned to a preset position. When the supporting device 100 is loaded with the cartridge 500, the compression ration to the elastic member 132 will increase till a balance is reached with respect to the cartridge 500. In a surge and bump is experienced, then the elastic member 132 will absorb the additional shock to keep the cartridge 500 from being negatively influenced. Once the cartridge 500 is removed therefrom, the elastic member 132 will bounce back to its original position, i.e. a situation when no cartridge 500 is loaded.

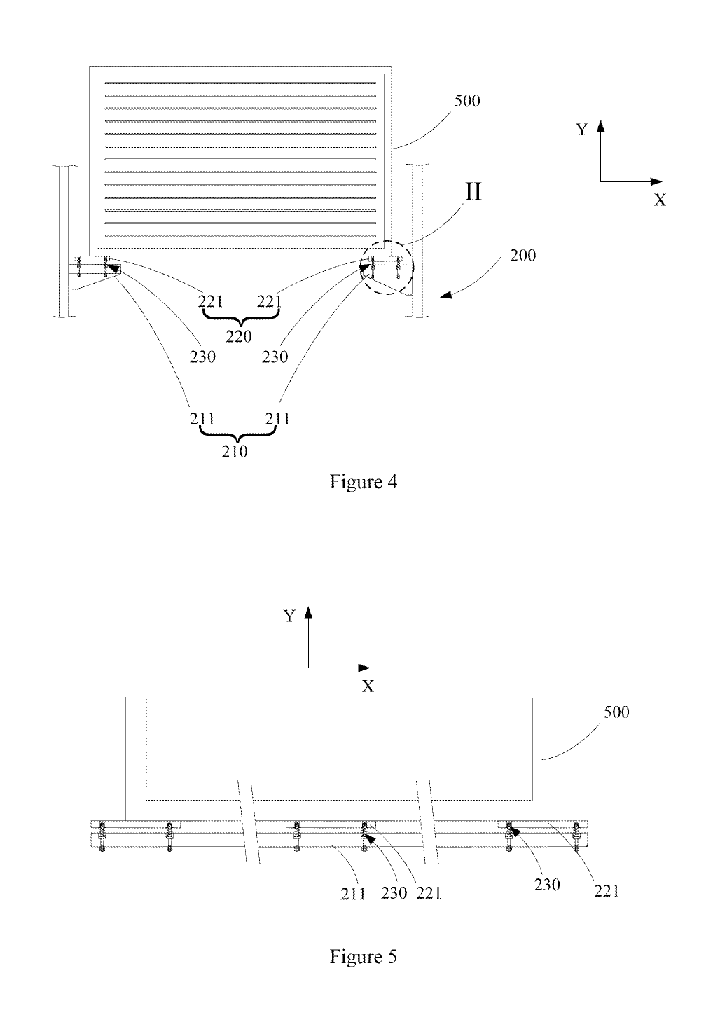

FIG. 4 is an illustrational and elevational view of a supporting apparatus made in accordance with a second embodiment of the present invention. FIG. 5 is a partially illustrational view or the supporting apparatus of FIG. 4. As shown in FIGS. 4 and 5, the supporting apparatus 200 for cartridge contained with glass substrates includes a first supporting member 210, a second supporting member 220, and at least a pair of buffering device 230. The first supporting member 210 includes a pair of supporting boards 211, and the second supporting member 220 includes at least second supporting boards 221.

The first and second supporting members 210 and 220 have the same configuration of the first and second supporting members 110 and 120 of the first embodiment, as a result, no detailed description is given.

The buffering device 230 is arranged between the first and second supporting surfaces. The buffering device 230 provides an attenuating effect to the cartridge 500 loaded onto the second supporting surface.

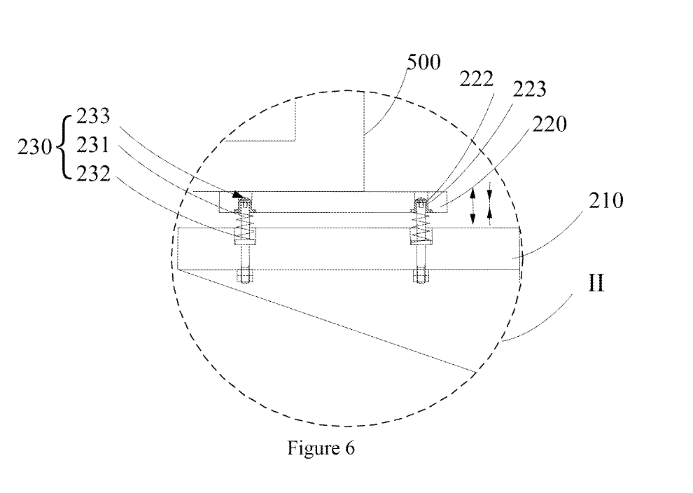

FIG. 6 is an enlarged view of an encircled portion II of the supporting apparatus shown in FIG. 4. As shown in FIG. 4, the buffering device 230 includes a guiding rod 231, an elastic member 232, and a stopper 233. The second supporting member 220 is defined with guiding hole 222 with a bushing 223 disposed therein.

The guiding rod 231, the guiding hole 222, the stopper 233 feature the identical or similar configuration of the guiding rod 131, the guiding hole 122, the bushing and the stopper 133 of the supporting device 100 according to the first embodiment, as a result, no detailed description is given herebelow.

The buffering device 230 is used to attenuate the downward momentum generated by the loading of the cartridge 500 onto the supporting apparatus 200. The difference between the buffering device 130 of the first embodiment, and the buffering device 230 of the second embodiment is that the buffering device 230 in the second embodiment embodies into a spring member 232 which envelops onto the guiding rod 231 so as to properly support the first and second supporting members 210 and 22.

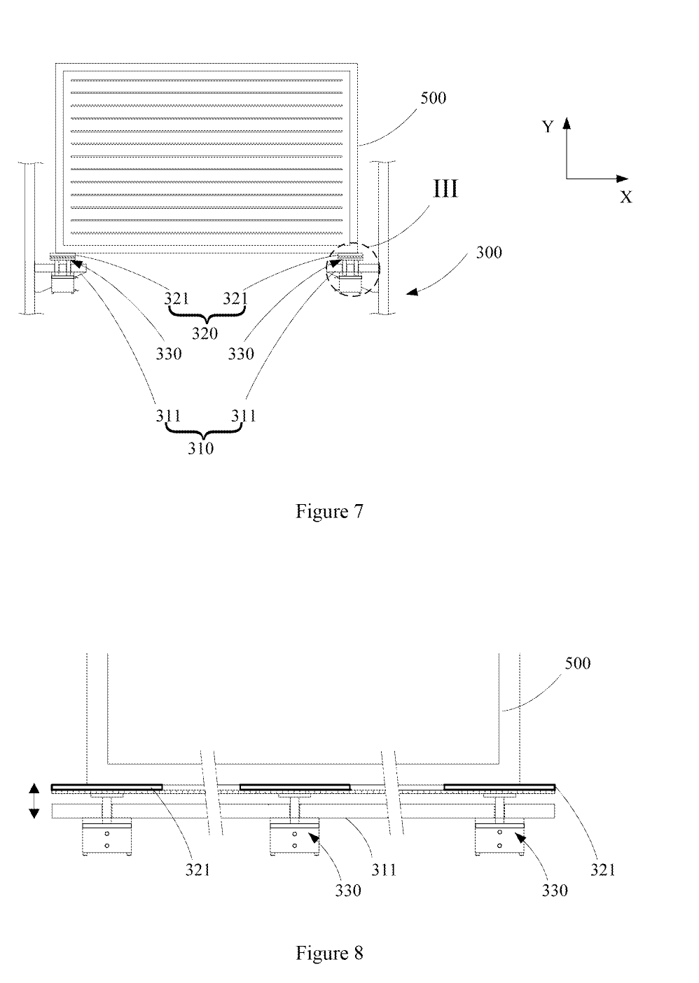

FIG. 7 is an illustrational and elevational view of a supporting apparatus made in accordance with a third embodiment of the present invention; and FIG. 8 is a partially illustrational view of the supporting apparatus of FIG. 7. As shown in FIGS. 7 and 8, the supporting apparatus 300 includes a first supporting member 310, a second supporting member 320 and at least two buffering device 330. The first supporting member 310 includes a pair of first supporting board 311; and the second supporting member includes at least a pair of second supporting boards 321.

The first and second supporting members 310 and 320 have the same configuration of the first and second supporting members 110 and 120 of the first embodiment, as a result, no detailed description is given.

The buffering device 330 is arranged between the first and second supporting surfaces. The buffering device 330 provides an attenuating effect to the cartridge 500 loaded onto the second supporting surface.

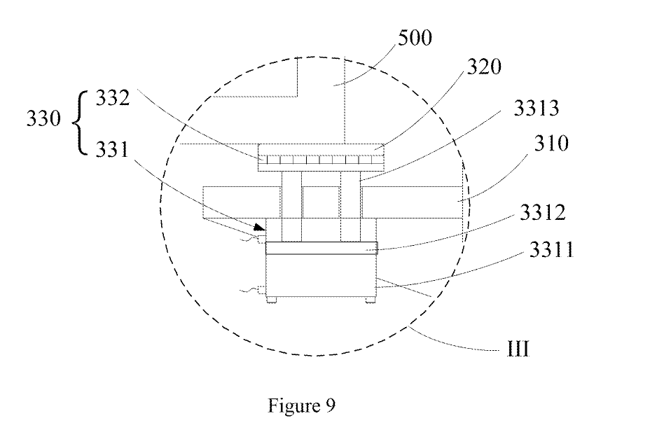

FIG. 9 is an enlarged view of an encircled portion III of the supporting apparatus shown in FIG. 7. As shown in FIG. 9, the buffering device 330 in this embodiment includes a cylinder 331 and a connecting board 332.

The cylinder 331 includes a body 3311, a piston 3312, and a piston rod 3313. The body 3311 is securely attached to the first supporting member 310. The piston 3312 is moveably disposed within the body 3311. A first end or the piston rod 3313 is attached to the piston 3312, and the other end or second end extends out of the body 3311, and eventually terminated to the second supporting member 320. Substantially, the connecting board 332 is used to interconnect the second ends of those two piston rods 3313 such that both ends of the piston rods 3313 can move up and down synchronically or simultaneously. The second supporting member 320 is fixedly attached to the connecting hoard 332.

Once the cylinder 331 is compressed by the displacement of the piston 3312, it can absorb the downward momentum when the cartridge 500 is loaded onto the supporting apparatus 300. Substantially, when the supporting apparatus 300 is unloaded with the cartridge 500, the piston rod 3312 is substantially extended out of the body 3311. Once the cartridge 500 is loaded onto the supporting apparatus 300, the piston rod 3312 starts to retreat into the body 3311 because of the load from the cartridge 500. During the downward displacement of the cylinder rod 3312, any unexpected vibration or shock generated can be effectively neutralized by the cylinder 331. Once the cartridge 500 is removed from the supporting apparatus 300, the piston rod 3312 will resume back to its original position.

Of course, it is feasible to interconnect the cylinder 331 with air source and with incorporation with valves and circuits, the upward and downward displacement of the cylinder 331 can be readily mitered.

As compared to the prior art supporting platform, the supporting apparatus made in accordance with the present invention can readily attenuate the shockwave resulted from a rough operation of placing the cartridge onto the supporting apparatus. As a result, breakage of the glass substrates contained within the cartridge resulted from vibrating and impact can be readily avoided. The supporting apparatus features a simple and compact configuration with lowered manufacturing cost, and it can be readily maneuvered.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A supporting apparatus for glass substrate, comprising:
A first supporting member creating a first supporting surface along a first horizontal direction;
A second supporting member creating a second supporting surface, and arranged spatially and perpendicular to the first supporting member; and
At least two buffering devices arranged between the first and second supporting surfaces for providing an attenuating effect when a fully loaded cartridge is landed thereupon.

2. The supporting apparatus as recited in claim 1, wherein the first supporting member is configured with at least two first supporting boards spatially arranged along the horizontal direction to define the first supporting surface, the second supporting member is configured with at least two second supporting boards spatially arranged along the horizontal direction to define the second supporting surface.

3. The supporting apparatus as recited in claim 1, wherein the buffering devices includes a cylinder configured by a body and a piston moveably disposed within the body, and a piston rod having a first end interconnected to the piston and a second end extending out of the body, the body is securely attached to the first supporting member, and the second supporting member is securely attached to the second end of the piston rod.

4. The supporting apparatus as recited in claim 1, wherein the buffering device further includes a connecting board interconnected to the second ends of the piston rod so as to simultaneously move upward and downward with the pistons within the body, the second supporting member is interconnected to the connecting board.

5. The supporting apparatus as recited in claim 1, wherein the buffering device includes a guiding rod and an elastic member, an end of the guiding rod is interconnected to the first supporting member and further extends along vertical direction, wherein the elastic member is enveloped onto the guiding rod and is arranged between the first and second supporting members.

6. The supporting apparatus as recited in claim 5, wherein the second supporting member is defined with a guiding hole in which a hushing is arranged for moveably supporting the second supporting member onto the guiding rod and to move along the guiding rod.

7. The supporting apparatus as recited in claim 6, wherein a stopper is arranged between the supporting member and the guiding rod so as to limit an upward stroke of the second supporting member.

8. The supporting apparatus as recited in claim 7, wherein the stopper includes a washer fixedly arranged on another end of the guiding rod limiting an upward movement of the second supporting by stopping the bushing of the second supporting member.

9. The supporting apparatus as recited in claim 5, wherein the elastic member is a spring or elastomer.

10. The supporting apparatus as recited in claim 1, wherein the second supporting member includes a plastic pad for supporting the cartridge thereon.

11. A supporting apparatus for glass substrate, comprising:
a first supporting member configured with at least two first supporting hoards spatially arranged along the horizontal direction to define the first supporting surface;
a second supporting member configured with at least two second supporting boards spatially arranged along the horizontal direction and disposed above the first supporting boards to define the second supporting surface which is vertically spatially with respect to the first supporting surface;
at least two buffering devices arranged between the first and second supporting surfaces for providing an attenuating effect when a loaded cartridge is landed thereupon, the buffering devices each including a cylinder configured by a body and a piston moveably disposed within the body, and a piston rod having a first end interconnected to the piston and a second end extending out of the body, the body is securely attached to the first supporting member, and the second supporting member is securely attached to the second end of the piston rod.

12. The supporting apparatus as recited in claim 11, wherein the buffering device further includes a connecting board interconnected to the second ends of the piston rod so as to simultaneously move upward and downward with the pistons within the body, the second supporting member is interconnected to the connecting board.

13. The supporting apparatus as recited in claim 11, wherein the second supporting member includes a plastic pad for supporting the cartridge thereon.

14. A supporting apparatus for glass substrate, comprising:
a first supporting member configured with at least two first supporting boards spatially arranged along the horizontal direction to define the first supporting surface;
a second supporting member configured with at least two second supporting boards spatially arranged along the horizontal direction and disposed above the first supporting boards to define the second supporting surface which is vertically spatially with respect to the first supporting surface;
at least two buffering devices arranged between the first and second supporting surfaces for providing an attenuating effect when a loaded cartridge is landed thereupon, wherein the buffering device includes a guiding rod and a elastic member, an end of the guiding rod is interconnected to the first supporting member and further extends along vertical direction, wherein the elastic member is enveloped onto the guiding rod and is arranged between the first and second supporting members.

15. The supporting apparatus as recited in claim 14, wherein the second supporting member is defined with a guiding hole in which a bushing is arranged for moveably supporting the second supporting member onto the guiding rod and to move along the guiding rod.

16. The supporting apparatus as recited in claim 15, wherein a stopper is arranged between the supporting member and the guiding rod so as to limit an upward stroke of the second supporting member.

17. The supporting apparatus as recited in claim 17, wherein the stopper includes a washer fixedly arranged on another end of the guiding rod limiting an upward movement of the second supporting by stopping the hushing of the second supporting member.

18. The supporting apparatus as recited in claim 14, wherein the elastic member is a spring or elastomer.

19. The supporting apparatus as recited in claim 1, wherein the second supporting member includes a plastic pad for supporting the cartridge thereon.
